(19) United States
(12) Patent Application Publication
(10) Pub. No.: US 2024/0094987 A1
(43) Pub. Date: Mar. 21, 2024

(54) COMPRESSOR CIRCUIT AND SEMICONDUCTOR INTEGRATED CIRCUIT INCLUDING THE SAME

(71) Applicant: Samsung Electronics Co., Ltd., Suwon-si (KR)

(72) Inventor: Byoung Gon Kang, Suwon-si (KR)

(21) Appl. No.: 18/329,856

(22) Filed: Jun. 6, 2023

(30) Foreign Application Priority Data
Sep. 21, 2022 (KR) 10-2022-0119442

(51) Int. Cl. G06F 7/501; G06F 30/392; H01L 27/118; H03K 17/00; H03K 19/21

(52) U.S. Cl. CPC G06F 7/501; G06F 30/392; H01L 27/11807; H03K 17/002; H03K 19/21; H01L 2027/11881; H01L 2027/11885

(57) ABSTRACT

A compressor circuit and a semiconductor integrated circuit included the compressor circuit are provided. The semiconductor integrated circuit includes a compressor circuit which includes a first full adder circuit which receives an A1 signal, a B1 signal, and a CI signal to output an IS signal and an ICO signal, and a second full adder circuit which receives a B2 signal, the IS signal, and a CI2 signal to output an S signal and a CO signal. Each of the first full adder circuit and the second full adder circuit are in an L-shaped layout, the first full adder circuit and the second full adder circuit have bent portions that are point-symmetrically engaged with each other, and the compressor circuit is in a rectangular shape. The number of transistors in the second full adder circuit is smaller than the number of transistors in the first full adder circuit.

### CROSS-REFERENCE TO RELATED APPLICATION

This application claims priority from Korean Patent Application No. 10-2022-0119442 filed on Sep. 21, 2022 in the Korean Intellectual Property Office, and all the benefits accruing therefrom under 35 U.S.C. 119, the contents of which in its entirety are herein incorporated by reference.

### BACKGROUND

The present disclosure relates to a compressor circuit, and more particularly, to a compressor circuit used in a multiplier.

Multiplication is used in the main operations of general purpose microprocessors and special purpose digital signal processors. The speed of the multiplication operation determines how fast the processors may run. In general, a multiplier performs a function of adding by generating a plurality of partial sums, and the performance of the multiplier depends on the addition performance. However, as technology evolves, users have been demanding data processing systems that perform faster functions. Accordingly, the size of the multiplier is increased, and it often occupies a significant portion of the central processing unit provided in the data processing system. A considerable amount of circuit area is required to perform multiplication on such a large amount of inputs.

The multiplier may reduce the complexity of wiring routing by using a 4-2 compressor circuit that connects two full adders.

### SUMMARY

Aspects of the present disclosure provide a compressor circuit having a small layout area and low power consumption and a semiconductor integrated circuit including the same.

Some embodiments of the present disclosure provides a compressor circuit including a first XNOR circuit configured to receive a first input signal and a second input signal and output a first xor signal and a first xnor signal, a first multiplexer circuit configured to output an intermediate carry signal by selection between the second input signal and a first input carry signal according to the first xor signal and the first xnor signal, a first XOR circuit configured to perform an XOR operation on the first input carry signal and the first xor signal to output an intermediate sum signal, a second XNOR circuit configured to receive the intermediate sum signal and a third input signal and output a second xor signal and a second xnor signal, a second multiplexer circuit configured to output a final carry signal by selection between the third input signal and a second input carry signal according to the second xor signal and the second xnor signal and a second XOR circuit configured to perform an XOR operation on the second input carry signal and the second xor signal to output a final sum signal.

Some embodiments of the present disclosure provides a semiconductor integrated circuit including a compressor circuit. The compressor circuit includes a first full adder circuit which receives an A1 signal, a B1 signal, and a CI signal to output an IS signal and an ICO signal, and a second full adder circuit which receives a B2 signal, the IS signal, and a CI2 signal, and configured to output an S signal and a CO signal. The second full adder circuit includes a first power metal line, a second power metal line, and a third power metal line extending in a first direction, and spaced apart from each other in a second direction at a predefined interval, a first inverter circuit disposed between the first power metal line and the second power metal line, and configured to invert the B2 signal to generate an nb2 signal, a first XNOR circuit between the second power metal line and the third power metal line, and configured to receive the IS signal and the B2 signal and output an xor22 signal and an xnor22 signal, a first XOR circuit adjacent to the first inverter circuit in the first direction between the first power metal line and the second power metal line, and configured to perform an XOR operation on the CI2 signal and the xor22 signal to output the S signal, a second inverter circuit adjacent to the first XNOR circuit between the second power metal line and the third power metal line, and configured to invert the CI2 signal to generate an nci2 signal and a first multiplexer circuit adjacent to the second inverter circuit in the first direction between the second power metal line and the third power metal line, and configured to output the B2 signal or the CI signal as the S signal according to the xor22 signal and the xnor22 signal.

Some embodiments of the present disclosure provides a semiconductor integrated circuit including a compressor circuit. The compressor circuit includes a first full adder circuit configured to receive an A1 signal, a B1 signal, and a CI signal, and configured to output an IS signal and an ICO signal, and a second full adder circuit which receives a B2 signal, the IS signal, and a CI2 signal, and configured to output an S signal and a CO signal. Each of the first full adder circuit and the second full adder circuit is in an L-shaped layout, the first full adder circuit and the second full adder circuit have bent portions that are point-symmetrically engaged with each other, and the compressor circuit is in a rectangular shape. The number of transistors in the second full adder circuit is smaller than the number of transistors in the first full adder circuit.

However, embodiments of the present disclosure are not restricted to the one set forth herein. The above and other aspects of the present disclosure will become more apparent to one of ordinary skill in the art to which the present disclosure pertains by referencing the detailed description of the present disclosure given below.

### BRIEF DESCRIPTION OF THE DRAWINGS

The above and other aspects and features of the present disclosure will become more apparent by describing in detail example embodiments thereof with reference to the attached drawings, in which:

FIG. 1 is a conceptual diagram illustrating a 4-2 compressor using a full adder.

FIG. 2 is a logic circuit diagram illustrating a 4-2 compressor circuit according to some embodiments.

FIG. 3 is a circuit diagram illustrating the first full adder circuit 10 according to some embodiments.

FIG. 4 is a circuit diagram illustrating the second full adder circuit 20 according to some embodiments.

FIG. 5 illustrates a front end of line (FEOL) layout of the first full adder circuit 10.

FIG. 6 illustrates a back end of line (BEOL) layout of the first full adder circuit 10.

FIG. 7 is a layout view illustrating FIGS. 5 and 6 together.

FIG. 8 is a layout view illustrating a transistor disposition in a semiconductor integrated circuit.

FIG. 9 shows a front end of line (FEOL) layout of a semiconductor integrated circuit.

FIG. 10 shows a back end of line (BEOL) layout of a semiconductor integrated circuit.

FIG. 11 is a layout view illustrating the layouts of FIGS. 9 and 10 together.

FIG. 12 is a layout view illustrating disposition of transistors in the semiconductor integrated circuit of FIG. 10.

FIG. 13 is a flowchart illustrating a method for fabricating a semiconductor integrated circuit (IC) according to some embodiments.

FIG. 14 is a block diagram illustrating a computing system including a memory that stores a program according to some embodiments.

### DETAILED DESCRIPTION

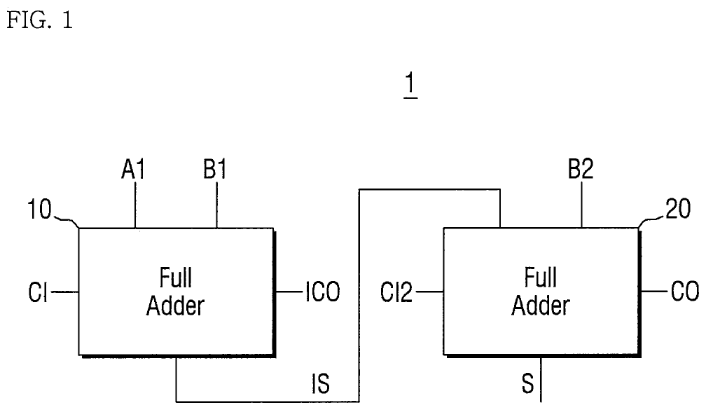

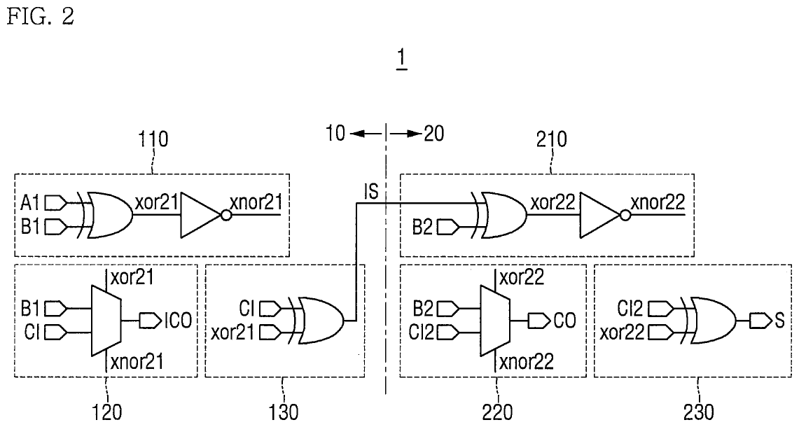

FIG. 1 is a conceptual diagram illustrating a 4-2 compressor using a full adder. FIG. 2 is a logic circuit diagram illustrating a 4-2 compressor circuit according to some embodiments.

Referring to FIG. 1, a 4-2 compressor 1 receives four data inputs and generates two final outputs, hence referred to as a 4-2 compressor circuit. The 4-2 compressor 1 receives A1, B1, B2 and CI as input data and generates final outputs S and CO.

According to some embodiments, the 4-2 compressor 1 may include two stages of full adder circuits 10 and 20 connected in a cascade form. As an input, the first full adder circuit 10 generates a sum IS of data and an intermediate carry ICO when two data A1 and B1 and a carry CI are inputted. The second full adder circuit 20 receives the sum IS and the intermediate carry ICO outputted from the first full adder circuit 10, and generates a final sum signal S and a final carry signal CO based on the new data B2, the received sum IS of the preceding stage, and the inputted carry CI.

Referring to FIG. 2, the 4-2 compressor 1 may be implemented with a plurality of logic circuits. According to some embodiments, each of the first full adder circuit 10 and the second full adder circuit 20 may include two XOR circuits, one multiplexer circuit, and one inverter circuit.

According to some embodiments, the first full adder circuit 10 may include an XNOR circuit 110, a multiplexer circuit 120, and an XOR circuit 130 at a logic gate level.

The XNOR circuit 110 may be implemented to include an XOR circuit and an inverter circuit. It is possible to receive input signals A1 and A2, perform an XOR operation to output an xor21 signal, and perform an inverter operation on the xor21 signal to output an xnor21 signal. The multiplexer circuit 120 may output either the input signal B1 or the input signal CI as the intermediate carry ICO based on the output xor21 signal and xnor21 signal generated by the XNOR circuit 110. For example, when the xor21 signal is enabled and the xnor21 signal is disabled, the multiplexer circuit 120 may output B1 as the intermediate carry ICO. For example, when the xor21 signal is disabled and the xnor21 signal is enabled, the multiplexer circuit 120 may output CI as the intermediate carry ICO. The XOR circuit 130 performs an XOR operation on the output xor21 signal from the XNOR circuit 110 with the input carry CI to output the intermediate sum signal IS.

According to some embodiments, the second full adder circuit 20 may include an XNOR circuit 210, a multiplexer circuit 220, and an XOR circuit 230 at a logic gate level.

The XNOR circuit 210 may be implemented to include an XOR circuit and an inverter circuit. It is possible to receive input signals IS and B2, perform an XOR operation to output an xor22 signal, and perform an inverter operation on the xor22 signal to output an xnor22 signal. The multiplexer circuit 220 may output either the input signal B2 or the input signal CI2 as the final carry CO based on the output xor22 signal and xnor22 signal generated by the XNOR circuit 210. For example, when the xor22 signal is enabled and the xnor22 signal is disabled, the multiplexer circuit 220 may output B2 as the final carry CO. For example, when the xor22 signal is disabled and the xnor22 signal is enabled, the multiplexer circuit 120 may output CI2 as the final carry CO. The XOR circuit 230 performs an XOR operation on the output xor22 signal from the XNOR circuit 210 with the input carry CI2 to output the final sum signal S.

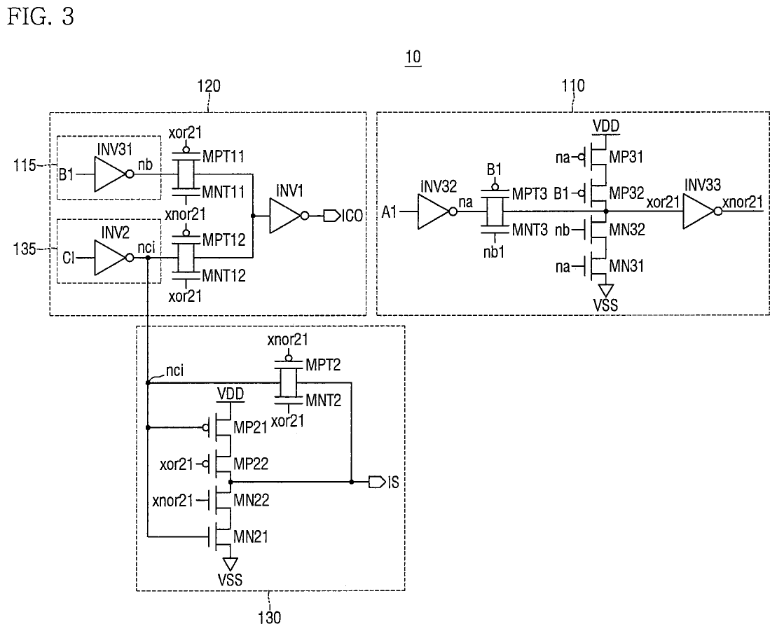

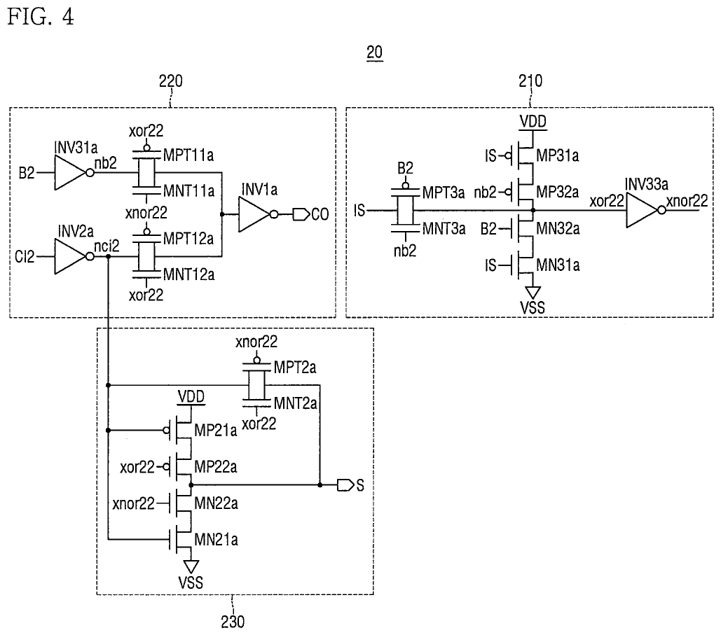

FIG. 3 is a circuit diagram illustrating the first full adder circuit 10 according to some embodiments, and FIG. 4 is a circuit diagram illustrating the second full adder circuit 20 according to some embodiments. It will be described with reference to FIG. 2 together.

Referring to FIG. 3, according to some embodiments, the XNOR circuit 110 of the first full adder circuit 10 may include an inverter INV32 circuit, a pair of pass transistors MPT3 and MNT3, transistor strings MP31, MP32, MN32, MN31, and inverter INV33. The inverter INV32 circuit inverts an A1 signal and outputs an na signal. The pass transistors MPT3 and MNT3 output the na signal corresponding to the B1 signal and an nb signal. The transistor string may include the MP31 transistor, the MP32 transistor, the MN32 transistor, and the MN31 transistor sequentially connected in series between a power supply terminal VDD and a power ground terminal VSS. The na signal is applied to the gate of the MP31 transistor, and the B signal is applied to the gate of the MP32 transistor. The nb signal obtained by inverting the B signal is applied to the gate of the MN32 transistor, and the na signal is applied to the gate of the MN31 transistor. The transistor strings MP31, MP32, MN32, MN31, and INV33 receive the na signal, the B signal, and the nb signal as inputs and output the xor21 signal. Specifically, the transistor string is a tri-state inverter circuit, and inverts and outputs the na signal according to the B signal and the nb signal. The inverter circuit INV33 of the first full adder circuit 10 inverts the xor21 signal to output the xnor21 signal.

The multiplexer circuit 120 of the first full adder circuit 10 may include three inverter circuits INV31, INV1, INV2 and two pairs of pass transistors MPT11-MNT11 and MPT12-MNT12. The inverter circuit INV31 inverts the B1 signal to output the nb signal. The pair of pass transistors MPT11-MNT11 outputs the nb signal to the inverter circuit INV1 corresponding to the xor21 signal and the xnor21 signal. The inverter circuit INV2 inverts the CI signal to output an nci signal. The pair of pass transistors MPT12-MNT12 outputs the nci signal to the inverter circuit INV1 corresponding to the xnor21 signal and the xor21 signal. The inverter circuit INV1 inverts the signal selected and outputted according to the xnor21 signal and the xor21 signal from the pairs of pass transistors MPT11-MNT11 and MPT12-MNT12 and outputs the inverted signal as the ICO signal.

The XOR circuit 130 of the first full adder circuit 10 receives the nci signal, the xnor21 signal, and the xor21 signal outputted from the multiplexer circuit 120 and outputs the IS signal. The XOR circuit 130 may include transistor strings MP21, MP22, MN22, and MN21 and a pair of pass transistors MPT2 and MNT2. The transistor string may include the MP21 transistor, the MP22 transistor, the MN22 transistor, and the MN21 transistor sequentially connected in series between a power supply terminal VDD and a power ground terminal VSS. The nci signal is applied to the gate of the MP21 transistor, and the xor21 signal is applied to the gate of the MP22 transistor. The xnor2 signal is applied to the gate of the MN22 transistor, and the nci signal is applied to the gate of the MN21 transistor. The transistor string receives the nci signal, the xor21 signal, and the xnor21 signal as inputs, and outputs the IS signal. The pair of pass transistors MPT2-MNT2 may output the nci signal as the IS signal corresponding to the xor21 signal and the xnor21 signal.

Referring to FIG. 4, according to some embodiments, the XNOR circuit 210 of the second full adder circuit 20 may include a pair of pass transistors MPT3a and MNT3a and transistor strings MP31a, MP32a, MN32a, MN31a, and inverter INV33a. The pass transistors MPT3a and MNT3a output the na signal corresponding to the B2 signal and an nb2 signal. The transistor string may include the MP31a transistor, the MP32a transistor, the MN32a transistor, and the MN31a transistor sequentially connected in series between the power supply terminal VDD and the power ground terminal VSS. The IS signal is applied to the gate of the MP31a transistor, and the nb2 signal is applied to the gate of the MP32a transistor. The B2 signal is applied to the gate of the MN32a transistor, and the IS signal is applied to the gate of the MN31a transistor. The transistor string receives the IS signal, the B2 signal, and the nb2 signal as inputs, and outputs the xor22 signal. The inverter circuit INV33a of the second full adder circuit 20 inverts the xor22 signal to output the xnor22 signal.

The multiplexer circuit 220 of the second full adder circuit 20 may include three inverter circuits INV31a, INV1a, and INV2a and two pairs of pass transistors MPT11a-MNT11a and MPT12a-MNT12a. The inverter circuit INV31a inverts the B2 signal to output the nb2 signal. The pair of pass transistors MPT11a-MNT11a outputs the nb2 signal to the inverter circuit INV1a corresponding to the xor22 signal and the xnor22 signal. The inverter circuit INV2a inverts the CI2 signal to output the nci2 signal. The pair of pass transistors MPT12a-MNT12a outputs the nci2 signal to the inverter circuit INV1a corresponding to the xnor22 signal and the xor22 signal. The inverter circuit INV1a inverts the signal selected and outputted according to the xnor22 signal and the xor22 signal from the pairs of pass transistors MPT11a-MNT11a and MPT12a-MNT12a and outputs the final carry signal, that is, the CO signal.

The XOR circuit 230 of the second full adder circuit 20 receives the nci2 signal, the xnor22 signal, and the xor22 signal outputted from the multiplexer circuit 220 and outputs the final sum signal S. The XOR circuit 230 may include transistor strings MP21a, MP22a, MN22a, and MN21a and a pair of pass transistors MPT2a and MNT2a. The transistor string may include the MP21a transistor, the MP22a transistor, the MN22a transistor, and the MN21a transistor sequentially connected in series between the power supply terminal VDD and the power ground terminal VSS. The nci2 signal is applied to the gate of the MP21a transistor, and the xor22 signal is applied to the gate of the MP22a transistor. The xnor22 signal is applied to the gate of the MN22a transistor, and the nci2 signal is applied to the gate of the MN21a transistor. The transistor string receives the nci2 signal, the xor22 signal, and the xnor22 signal as inputs, and outputs the S signal. The pair of pass transistors MPT2a-MNT2a may output the nci2 signal as the S signal corresponding to the xor22 signal and the xnor22 signal.

The second full adder circuit 20 may have one less inverter circuit INV32 than the first full adder circuit 10. The number of total transistors that form the 4-2 compressor 1 may be reduced by using the intermediate sum signal IS of the first full adder circuit 10 as it is without re-inversion.

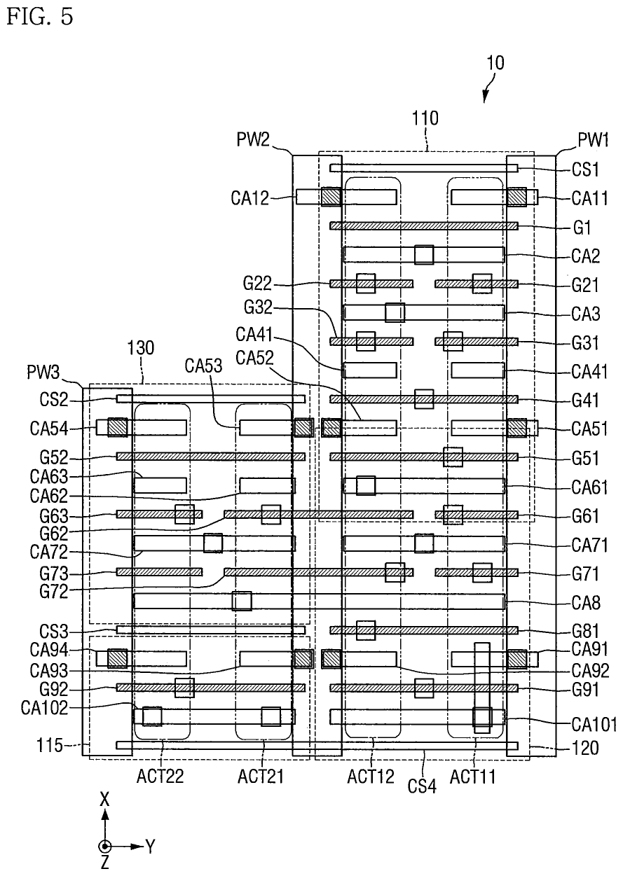

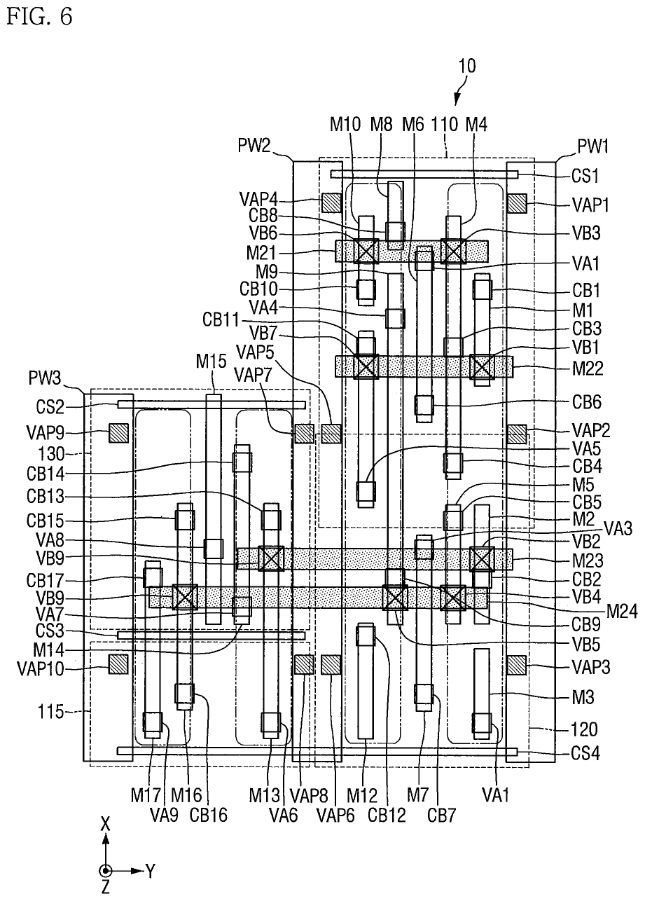

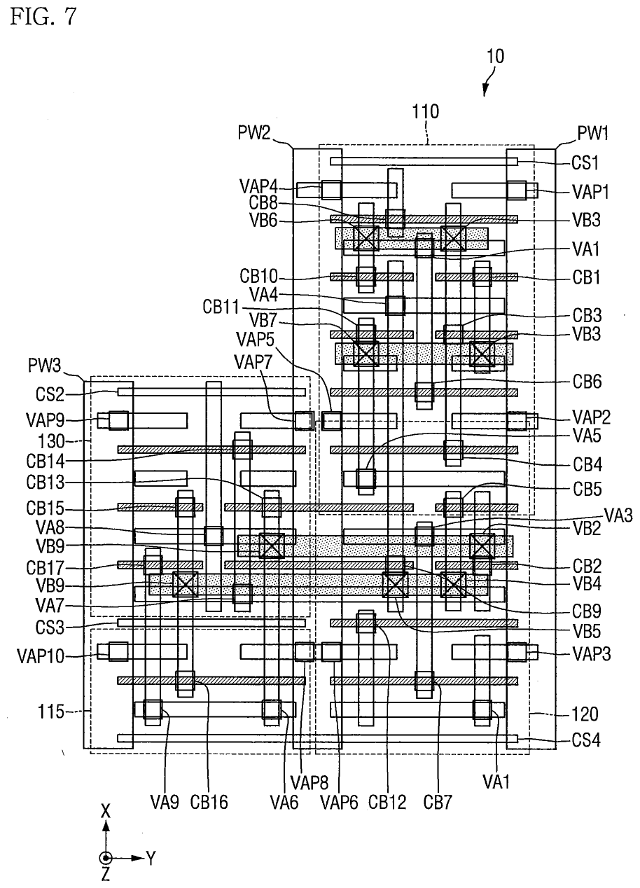

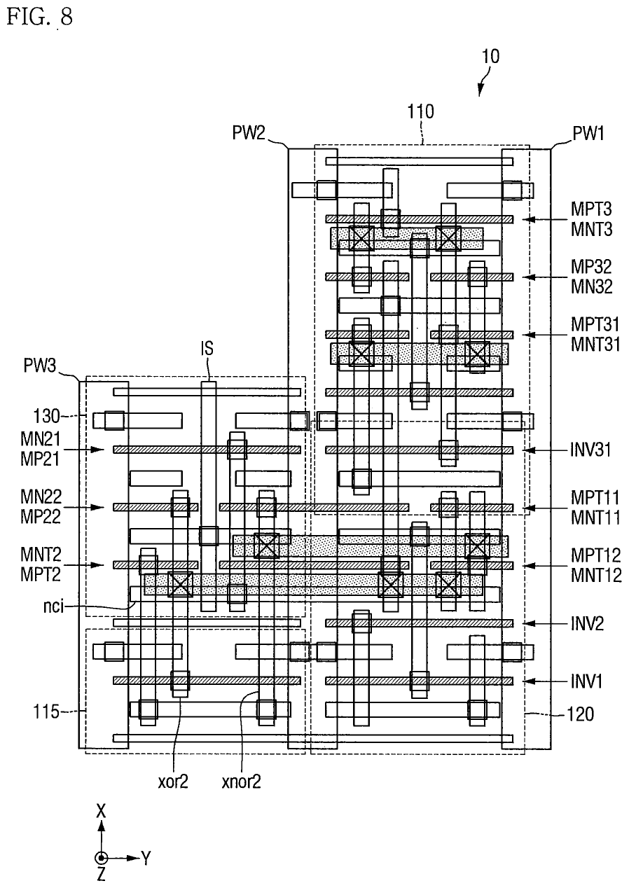

FIGS. 5 to 8 are layout views of a semiconductor integrated circuit illustrating the first full adder circuit 10 according to some embodiments. FIG. 5 illustrates a front end of line (FEOL) layout of the first full adder circuit 10, FIG. 6 illustrates a back end of line (BEOL) layout of the first full adder circuit 10, and FIG. 7 is a layout view illustrating FIGS. 5 and 6 together. FIG. 8 is a layout view illustrating a transistor disposition in a semiconductor integrated circuit.

Referring to FIGS. 5 to 8, the semiconductor integrated circuit of the first full adder circuit 10 includes active regions ACT11, ACT12, ACT21, and ACT22, gate stacks G1, G21, G22, G31, G32, G41, G51, G52, G61, G62, G63, G71, G72, G73, G81, G91, and G92, insulating gates CS1, CS2, CS3, and CS4, active contacts CA11, CA12, CA2, CA3, CA41, CA42, CA51, CA52, CA53, CA54, CA61, CA62, CA63, CA71, CA72, CA8, CA91, CA92, CA93, CA94, CA101, and CA102 formed on a substrate at the FEOL level.

In the semiconductor integrated circuit, the first full adder circuit 10 may include a plurality of logic circuits disposed in a double height. The double height means that it is disposed in two rows based on power metal lines PW1, PW2, and PW3. For simplicity of description, in some embodiments, an X direction is referred to as a row direction and a Y direction is referred to as a column direction, but the present disclosure is not limited thereto. The directions may be referred to in the opposite way or may be referred to as a first direction and a second direction. For example, in the double height disposition, it means that the power metal line PW1 and the power metal line PW2 are set as the first row, the power metal line PW2 and the power metal line PW3 are set as the second row, and a logic circuit is implemented separately in each row or across two rows.

A semiconductor integrated circuit may be formed on a substrate. The substrate may be a silicon substrate or silicon-on-insulator (SOI) substrate. In some embodiments, the substrate may include silicon germanium, silicon germanium on insulator (SGOI), indium antimonide, a lead tellurium compound, indium arsenide, indium phosphide, gallium arsenide, or gallium antimonide, but is not limited thereto.

The active regions ACT11, ACT12, ACT21, and ACT22 may be defined along the X direction. The active region may be defined along the X direction. The active region may be defined by a deep trench, the active regions ACT11 and ACT22 may be well regions doped with a P-type impurity and may be regions in which a P-type transistor is formed, and the active regions ACT12 and ACT21 may be well regions doped with an N-type impurity and may be regions in which an N-type transistor is formed. The active regions ACT11, ACT12, ACT21, and ACT22 may be defined to be spaced apart from each other in the Y direction. For example, a space between the active region ACT11 and the active region ACT12 and a space between the active region ACT21 and the active region ACT22 may extend in the X direction to be separated by an active region separation film having a deep trench structure. For example, the active regions ACT11, ACT12, ACT21, and ACT22 may include a FIN pattern or an RX pattern.

The gate stacks G1, G21, G22, G31, G32, G41, G51, G52, G61, G62, G63, G71, G72, G73, G81, G91, and G92 and the insulating gates CS1, CS2, CS3, and CS4 may be spaced apart by 1 contacted poly pitch (CPP) in the X direction. For example, the insulating gate CS1 and the gate stack G1 are spaced apart by 1 CPP in the X direction, and the gate stack G1 and the gate stacks G21 and G22 are spaced apart by 1 CPP in the X direction. In addition, after the gate stacks G21, G22, G31, G32, G41, G51, G52, G61, G62, G63, G71, G72, G73, G81, G91, and G92 may be formed to extend across the first row and the second row, and may be distinguished by a gate cutting pattern. For example, the gate stack G21 and the gate stack G22 may be formed as one gate stack on the same axis, and then may each be distinguished by a gate cutting pattern.

The insulating gates CS1, CS2, CS3, and CS4 may separate the active region in the X direction. For example, the insulating gate CS3 may distinguish the active region ACT21 and the active region ACT22 to be spaced apart from each other in the X direction. When the fabricating process of forming the insulating gate CS3 is considered, after removing at least a part of each of the active region ACT21, the active region separation film, and the active region ACT22, the insulating gate CS3 formed as an insulating material is filled in the portion in which the active region ACT21, the active region separation film, and the active region ACT22 are removed. Accordingly, a part of the sidewall of the insulating gate CS3 may be in contact with the active region ACT21, the active region separation film, and the active region ACT22. For example, a gate spacer may be disposed on a sidewall of the insulating gate CS3. For example, the insulating gates CS1, CS2, and CS4 may distinguish cells constituting the full adder circuit 10 from adjacent cells. Since the insulating gates CS1, CS2, and CS4 are also formed in the same fabricating process as the insulating gate CS3, a detailed description thereof will be omitted.

The P-type transistors of the full adder circuit 10 illustrated in FIG. 3 may be formed at positions at which the gate stacks G1, G21, G31, G32, G41, G51, G52, G61, G63, G71, G73, G81, G91, and G92 and the active regions ACT11 and ACT22 intersect, and the N-type transistors may be formed at positions at which the gate stacks G1, G22, G32, G41, G51, G52, G62, G72, G91, and G92 and the active regions ACT12 and ACT21 intersect.

The active contacts CA11, CA12, CA2, CA3, CA41, CA42, CA51, CA53, CA53, CA54, CA61, CA62, CA63, CA71, CA72, CA8, CA91, CA92, CA93, CA94, CA101, and CA102 may be disposed on the active regions ACT11, ACT12, ACT21, and ACT22. The active contacts CA11, CA12, CA2, CA3, CA41, CA42, CA51, CA53, CA53, CA54, CA61, CA62, CA63, CA71, CA72, CA8, CA91, CA92, CA93, CA94, CA101, and CA102 may be connected to the semiconductor pattern formed on the active regions ACT11, ACT12, ACT21, and ACT22. A semiconductor pattern (not illustrated) may be formed between adjacent gate stacks and an insulating gate. The semiconductor pattern may be formed by forming a recess by removing a part of the active region and then filling the recess through an epitaxial process.

The active contacts CA2, CA3, CA41, CA42, CA61, CA62, CA63, CA71, CA72, CA8, CA101, and CA102 may overlap the active regions ACT11, ACT12, ACT21, and ACT22. The lengths of the active contacts CA2, CA3, CA41, CA42, CA61, CA62, CA63, CA71, CA72, CA8, CA101, and CA102 in the Y direction may be formed differently depending on a position at which the wiring metal line is to be formed, based on a boundary between the active region and the active region separation film.

The semiconductor integrated circuit includes a plurality of first level wiring metal lines M1 to M16 and the power metal lines PW1, PW2, PW3 extending in the X direction and second level wiring metal lines M21 to M24 extending in the Y direction. The first level wiring metal lines M1 to M16 may be formed to extend in the X direction, and may be disposed to be spaced apart from each other on a predefined axis on the active region and the active region separation film. For example, the first level wiring metal lines M1, M2, and M3 may be formed on the same X direction axis and disposed to be spaced apart from each other in the X direction. For example, the first level wiring lines M4 and M5 may be formed on a different X direction axis from the first level wiring lines M1, M2 and M3 and may be disposed to be spaced apart from each other in the Y direction. The second level wiring metal lines M21 to M24 are formed to extend in the Y direction and spaced apart from each other in the X direction. The power metal lines PW1, PW2, and PW3 may be formed to extend in the X direction, and may be formed to have a wider width (the width in the Y direction) than the first level wiring metal lines M1 to M16. Adjacent power metal lines are disposed with a predefined separation distance from each other in the Y direction. As described above, it may be distinguished into a single-height disposition or a multi-height disposition based on the power metal line. The power metal lines PW1, PW2, and PW3 may be electrically connected to the active contacts CA11, CA12, CA51, CA52, CA53, CA54, CA91, CA92, CA93, and CA94 through power vias VAP1 to VAP10.

The gate contacts CB1 to CB17 are formed on the gate stacks G1 to G92 and are not formed on the insulating gates CS1, CS2, CS3, and CS4. For simplicity of description, when the disposition of the gate contact-gate stack is described as a pair, the disposition may be set as CB1-G21 (i.e., CB1 is disposed on G21), CB2-G71, CB3-G31, CB4-G51, CB5-G61, CB6-G4, CB7-G91, CB8-G1, CB9-G72, CB10-G22, CB11-G32, CB12-G8, CB13-G62, CB14-G52, CB15-G63, CB16-G92, and CB17-G73.

The gate contacts CB1 to CB17 are formed at points intersecting the first level wiring metal lines M1 to M17 on the gate stack to electrically connect the gate stack and the first level wiring metal lines M1 to M17. For example, the gate contact CB3 electrically connects the gate stack G31 and the first level wiring metal line M4. That is, the gate contact CB1 is formed under the first level wiring metal line M1, the gate contact CB2 and an active via VA1 are formed under the first level wiring metal line M2, the gate contacts CB3 and CB4 are formed under the first level wiring metal line M4, the gate contact CB5 is formed under the first level wiring metal line M5, the gate contact CB6 is formed under the first level wiring metal line M6, and the gate contact CB7 and an active via VA3 are formed under the first level wiring metal line M7. The gate contact CB8 is formed under the first level wiring metal line M8, and the gate contact CB9 and an active via VA4 are formed under the first level wiring metal line M9. The gate contact CB10 is formed under the first level wiring metal line M10, the gate contact CB11 and an active via VA5 are formed under the first level wiring metal line M11, and the gate contact CB12 is formed under the first level wiring metal line M12. The gate contact CB13 and an active via VA6 are formed under the first level wiring metal line M13. The gate contact CB14 and an active via VA7 are formed under the first level wiring metal line M14. An active via VA8 is formed under the first level wiring metal line M15, the gate contacts CB15 and CB16 are formed under the first level wiring metal line M16, and the gate contact CB17 and an active via VA9 are formed under the first level wiring metal line M17.

The active vias VA1 to VA8 are formed on the active contact and electrically connect the active contact and the first level wiring metal lines M1 to M17. For simplicity of description, when the disposition of active via-active contact is described as a pair, the disposition is set as VA1-CA101, VA2-CA2, VA3-CA71, VA4-CA3, VA5-CA61, VA6-CA12, VA7-CA8, VA8-CA72, and VA9-CA12.

Vias VB1 to VB9 are formed on the first level wiring metal lines M1 to M17, and are disposed at points at which the first level wiring metal lines M1 to M17 and the second level wiring metal lines M21 to M24 intersect. For simplicity of description, when the disposition of the first level wiring metal line-via-second wiring metal line is described as a pair, the disposition is set as M1-VB1-M22, M2-VB2-M23, M4-VB3-M21, M5-VB4-M24, M9-VB5-M24, M10-VB6-M21, M11-VB7-M22, M13-VB8-M23, and M16-VB9-M24. That is, the vias VB3 and VB6 are formed under the second level wiring metal line M21, the vias VB1 and VB7 are formed under the second level wiring metal line M22, the vias VB2 and VB8 are formed under the second level wiring metal line M23, and the vias VB4, VB5, and VB9 are formed under the second level wiring metal line M24.

Since the XNOR circuit 110 of the first full adder circuit 10 includes an XOR circuit and an inverter circuit, the XNOR circuit 110 is disposed across a first region including the insulating gate CS1 up to the gate stacks G61 and G62 in the first row between the power metal line PW1 and the power metal line PW2 and a second region 115 including the insulating gate CS3 up to the insulating gate CS4 in the second row between the power metal line PW2 and the power metal line PW3.

An A1 signal is applied to the first level wiring metal line M1 and a B signal is applied to the second level wiring metal line M21. The inverter circuit INV32 of the XNOR circuit 110 may be implemented by the active contacts CA11, CA12, and CA2 on the active regions ACT11 and ACT12 and the gate stack G1. The inverter circuit INV32 receives the input A1 signal through the gate stack G1 and outputs the na signal obtained by inverting the A1 signal, through the active contact CA2 and the first level wiring metal line M6.

The pair of pass transistors MPT3 and MNT3 is implemented in the gate stacks G21 and G22, respectively. The transistor strings MP31, MP32, MN32, and MN31 are implemented in the gate stacks G31, G32, and G41. The MP32 transistor and the MN32 transistor are implemented in the gate stacks G31 and G32 and the active contacts CA41 and CA42, respectively, and the MP31 transistor and the MN31 transistor share the active contacts CA41 and CA42 with the MP32 transistor and the MN32 transistor, and are implemented through the active contacts CA51 and CA52 and the gate stack G41, respectively.

The gate stack G41 receives the output na signal of the inverter circuit INV32 by being electrically connected to the active contact CA2 and the first level wiring metal line M6.

The first level wiring metal line M4 is connected to the second level wiring metal line M21 through the via VB3 to receive the input signal B. The first level wiring metal line M4 is connected to the gate stack G51 through the via CB4. The inverter circuit INV31 is implemented in the gate stack G51 and the active contacts CA51, CA52, and CA61. The inverter circuit INV31 generates the nb signal through the active contact CA61, and the signal is inputted to the pass transistor MNT3 through the gate contact CB11 and the gate stack G32. The B signal is inputted to the pass transistor MPT3 through the gate stack G31.

The output xor21 signal of the pair of pass transistors MPT3 and MNT3 is outputted through the active contact CA3, and the signal of the active contact CA3 is passed through the first level wiring metal line M9 and is outputted to the second level wiring metal line M24. The inverter circuit INV33 is implemented in the gate stack G92 and the active contacts CA93, CA94, and CA102 in the second row. The gate stack 92 receives the xor21 signal through the first level wiring metal line M16 electrically connected to the second level wiring metal line M24, and generates the xnor21 signal through the active contact CA102.

The multiplexer circuit 120 is disposed in a region including the active contacts CA51 and CA52 up to the insulating gate CS4 in the first row between the power metal line PW1 and the power metal line PW2. The transistor strings MP21, MP22, MN22, and MN21 are implemented on the active contacts CA53, CA54, CA62, CA63, and CA72 and the gate stacks G52, G62, and G63. The MN21 transistor and the MP21 transistor are implemented in the active contacts CA53, CA54 and the gate stack G52, and the MN22 transistor and the MP22 transistor are implemented in the active contacts CA62, CA63, and CA72 and the gate stacks G62 and G63 and output the intermediate sum signal IS through the active contact CA72. The pass transistors MPT2 and MNT2 are implemented in the gate stacks G72 and G73 and the active contact CA8, and output the nci signal inputted to the active contact CA8 as the sum signal IS through the active contact CA72 according to the xnor21 signal and the xor21 signal inputted to each of the gate stacks G72 and G73.

The XOR circuit 130 is disposed in a region including the insulating gate CS2 up to the insulating gate CS3 in the second row between the power metal line PW2 and the power metal line PW3. The inverter circuit INV2 is implemented in the active contacts CA91, CA92, and CA8 and the gate stack G81. When the input CI signal is applied to the first level wiring metal line M12 and the gate stack G81, the inverted nci signal is generated in the active contact CA8. The pass transistors MPT11 and MNT11 are implemented in the gate stacks G61 and G62 and the active contacts CA61 and CA71, and the pass transistors MPT12 and MNT12 are implemented in the gate stacks G71 and G72 and the active contact CA71.

The inverter circuit INV1 is implemented in the gate stack G91 and the active contacts CA92, CA92, and CA101, and the gate stack G91 is electrically connected to the active contact CA71 in which the output signals of the pass transistors MPT11, MNT11, MPT12, and MNT12 are generated through the first level wiring metal line M7. That is, the ICO signal is generated in the active contact CA101 by inverting the output signals of the pass transistors.

That is, the first full adder circuit 10 receives the input data A1 signal through the first level wiring metal line M1, receives the input data B signal through the first level wiring metal lines M4 and M10, and receives the input carry CI signal through the first level wiring metal line M12.

The first level wiring metal line M1 transmits the A1 signal, the first level wiring metal line M2 transmits the ICO signal, the first level wiring metal line M3 transmits the xnor21 signal, and the first level wiring metal line M4 transmits the B signal. The first level wiring metal line M5 transmits the xor21 signal, the first level wiring metal line M6 transmits the na signal, and the first level wiring metal line M7 transmits the xor21 signal. The first level wiring metal line M8 transmits the A1 signal, the first level wiring metal line M9 transmits the xor21 signal, the first level wiring metal line M10 transmits the A1 signal, the first level wiring metal line M11 transmits the A1 signal, and the first level wiring metal line M12 transmits the CI signal.

The first level wiring metal line M13 transmits the xnor21 signal, the first level wiring metal line M14 transmits the nci signal, the first level wiring metal line M15 transmits the IS signal, the first level wiring metal line M16 transmits the xor21 signal, and the first level wiring metal line M17 transmits the ICO signal.

The second level wiring metal line M21 transmits the B signal, the second level wiring metal line M22 transmits the nb signal, the second level wiring metal line M23 transmits the xnor21 signal, and the second level wiring metal line M24 receives the xor21 signal and transmits the xor21 signal to each transistor. In addition, the active region CA8 generates and outputs the nci signal. The nci signal may be generated in the active contact CA8 by inverting the input carry signal CI applied to the first level wiring metal line M12 by the inverter circuit INV2.

The second level wiring metal line M23, the second level wiring metal line M24, and the active contact CA8 may elongate in the Y direction and may be disposed to cross both the first row and the second row that are distinguished into the power metal lines PW1, PW2, and PW3. According to the place and routing (PnR) disposition, the xnor21 signal, the xor21 signal, and the nci signal may be provided by being electrically connected to the gate stack of transistors (e.g., MPT11, MNT11, MPT12, MNT12, MPT2, MNT2, MP21, MP22, MN22, and MN21) required for each of the first full adder circuits 10.

Meanwhile, the first level wiring metal line M15 may be disposed to elongate in the X direction while intersecting the insulating gate CS2 that is the boundary of the first full adder circuit 10 in order to be connected to another adjacent full adder, for example, the second full adder circuit 20.

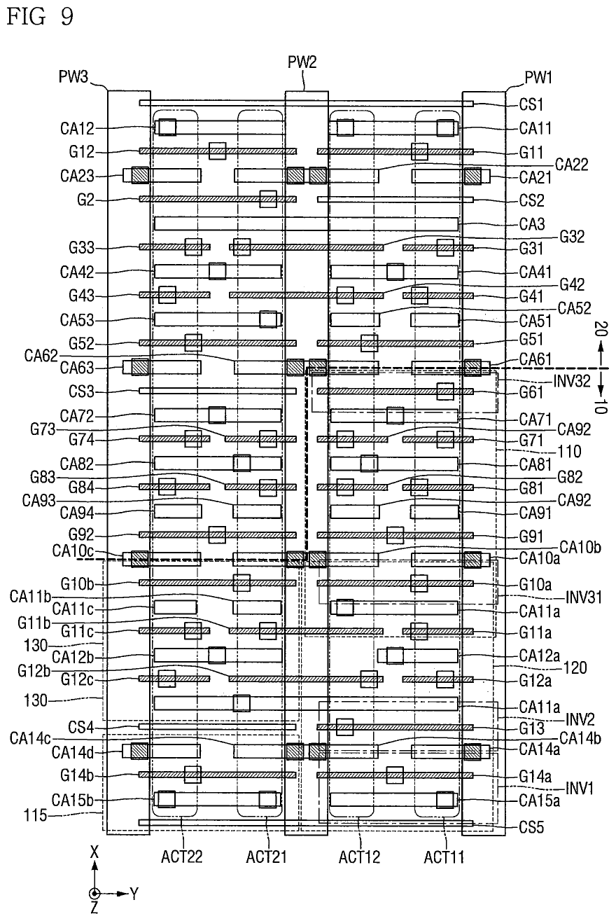

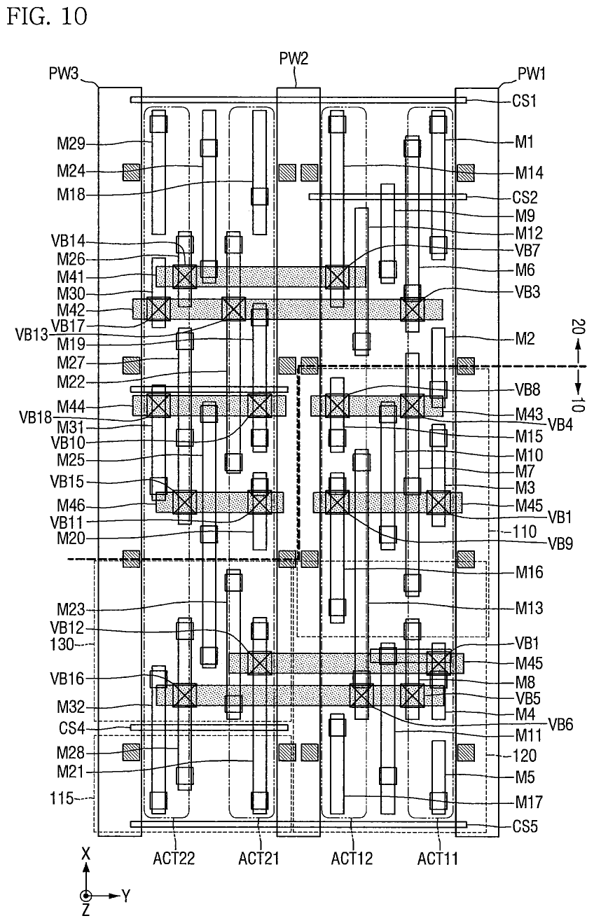

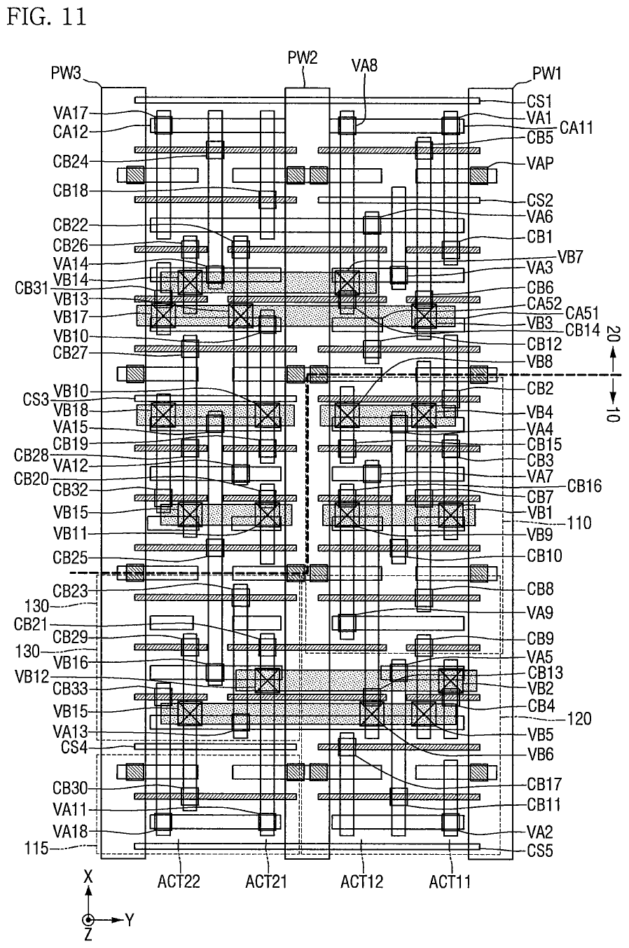

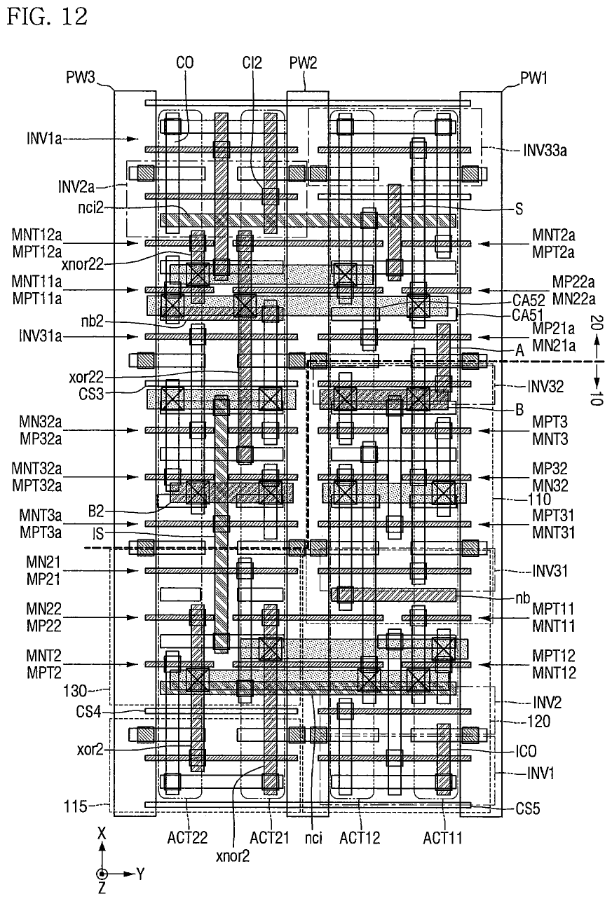

FIGS. 9 to 12 are layout views illustrating a semiconductor integrated circuit including a 4-2 compressor, according to some embodiments. FIG. 9 shows a front end of line (FEOL) layout of a semiconductor integrated circuit, FIG. 10 shows a back end of line (BEOL) layout of a semiconductor integrated circuit, FIG. 11 is a layout view illustrating the layouts of FIGS. 9 and 10 together, and FIG. 12 is a layout view illustrating disposition of transistors in the semiconductor integrated circuit of FIG. 10. For simplicity of description, descriptions overlapping those of FIGS. 5 to 8 will be omitted.

Referring to FIGS. 9 to 12, the semiconductor integrated circuit of the 4-2 compressor circuit 1 includes the active regions ACT11, ACT12, ACT21, and ACT22, the gate stacks G11, G12, G2, G31, G32, G33, G41, G42, G43, G51, G52, G61, G71, G72, G73, G74, G81, G82, G83, G84, G91, G92, G10a, G10b, G11a, G11b, G11c, G12a, G12b, G12c, G13, G14a, and G14b, the insulating gates CS1, CS2, CS3, CS4, and CS5, the active contacts CA11, CA12, CA21, CA22, CA23, CA3, CA41, CA42, CA51, CA52, CA53, CA61, CA62, CA63, CA71, CA72, CA81, CA82, CA91, CA92, CA93, CA94, CA10a, CA10b, CA10c, CA11a, CA11b, CA11c, CA12a, CA12b, CA13, CA14a, CA14b, CA14c, CA15a, and CA15b formed on a substrate at the FEOL level.

The semiconductor integrated circuit including the 4-2 compressor circuit 1 may be formed with a width of 15 critical poly pitch (CPP) (width in the X direction) and may be disposed as a double height including three power metal lines. Based on the portion illustrated by the dotted line, the upper portion in the X direction is the second full adder circuit 20, and the first full adder circuit 10 is disposed in the lower portion in the X direction. Since the disposition of the first full adder circuit 10 overlaps those described with reference to FIGS. 5 to 7, a description of the layout of the first full adder circuit 10 will be omitted.

The semiconductor integrated circuit includes the power metal lines PW1, PW2, and PW3, the first level wiring metal lines M1 to M32, and the second level wiring metal lines M41 to M48. The power metal lines PW1, PW2, and PW3 and the first level wiring metal lines M1 to M32 are disposed to elongate in the X direction, and the second level wiring metal lines M41 to M48 are disposed to extend in the Y direction.

Each of the first level wiring metal lines M1 to M17 is disposed on five X axes between the power metal line PW1 and the power metal line PW2. For example, (M1, M2, M3, M4, M5), (M6, M7, M8), (M9, M10, M11), (M12, M13), and (M14, M15, M16, M17) enclosed in parentheses are disposed on the X axes, respectively while being spaced apart from each other in the X-axis direction. The five X axes are parallel while being spaced apart from each other in the Y direction by a predefined distance. Each of the first level wiring metal lines M18 to M32 is disposed on five X axes between the power metal line PW2 and the power metal line PW3. For example, (M18, M19, M20, M21), (M22, M23), (M24, M25), (M26, M27, M28), and (M29, M30, M31, M32) enclosed in parentheses are disposed on the X axes, respectively while being spaced apart from each other in the X-axis direction. The five X axes are parallel while being spaced apart from each other in the Y direction by a predefined distance.

The second level wiring metal lines M41, M42, M44, and M46 transmit signals from the second full adder circuit 20. The second level wiring metal lines M43, M45, M47, and M48 transmit signals from the first full adder circuit 10. The second level wiring metal line may be disposed to elongate in the Y direction to cross both the first row and the second row of the double height disposition according to some embodiments to correspond to the signal connection relationship (e.g., M41, M42, M47, and M48), and according to some embodiments, may be disposed to extend in the Y direction only in one of the first row and the second row of the single height (e.g., M43, M44, M45, and M46).

The semiconductor integrated circuit includes the gate contacts CB1 to CB33 and the active vias VA1 to VA18 and VAP1 to VAP10 to connect the metal lines PW1, PW2, PW3, M1 to M32, and M41 to M48 with a gate stack and an active contact, and includes the vias VB1 to VB18 to make connection between the metal lines.

The first full adder circuit 10 receives the input data A1 signal through the first level wiring metal line M2, receives the input data B signal through the first level wiring metal lines M7 and M15 and the second level wiring metal line M43, and receives the input carry CI signal through the first level wiring metal line M17.

The first level wiring metal line M2 transmits the A1 signal, the first level wiring metal line M5 transmits the ICO signal, the first level wiring metal lines M4 and M21 transmit the xnor21 signal, and the first level wiring metal lines M7 and M15 transmit the B signal. The first level wiring metal lines M8, M13, and M28 transmit the xor21 signal, and the first level wiring metal lines M3 and M16 transmit the nb signal. The first level wiring metal line M10 transmits the na signal, the first level wiring metal line M17 transmits the CI signal, and the first level wiring metal line M25 transmits the IS signal.

The second level wiring metal line M43 transmits the B signal, the second level wiring metal line M45 transmits the nb signal, the second level wiring metal line M47 transmits the xnor21 signal, and the second level wiring metal line M48 transmits the xor21 signal to each transistor. In addition, the active region CA13 generates and outputs the nci signal. The nci signal may be generated in the active contact CA13 by inverting the input carry signal CI applied to the first level wiring metal line M17 by the inverter circuit INV2.

The second full adder circuit 20 receives the input data IS signal through the first level wiring metal line M25, receives the input data B2 signal from the first level wiring metal lines M20 and M27 through the second level wiring metal line M46, and receives the input carry CI2 signal through the first level wiring metal line M18.

Specifically, the first level wiring metal lines M20 and M27 transmit the B2 signal, the first level wiring metal line M29 generates the CO signal, the first level wiring metal lines M22 and M6 transmit the xor22 signal, and the first level wiring metal lines M26 and M14 transmit the xnor22 signal. The first level wiring metal line M9 transmits the S signal, and the first level wiring metal lines M30 and M19 transmit the nb2 signal.

The second level wiring metal line M46 transmits the B2 signal, the second level wiring metal line M44 transmits the nb2 signal, the second level wiring metal line M41 transmits the xnor21 signal, and the second level wiring metal line M42 transmits the xor21 signal to each transistor. That is, the multiplexer circuit 220 and the XOR circuit 230 may be disposed adjacent to each other in the Y direction to share the second level wiring metal line M42 and the second level wiring metal line M41. In addition, the active region CA3 generates and outputs the nci2 signal. The nci signal may be generated in the active contact CA3 by inverting the input carry signal CI2 applied to the first level wiring metal line M18 by the inverter circuit INV2a.

The XNOR circuit 210 of the second full adder circuit 20 includes the remaining transistors after the INV32 circuit is excluded from the XNOR circuit 110 of the first full adder circuit 10. Specifically, the XNOR circuit 210 of the second full adder circuit 20 is disposed in a third region including the insulating gate CS3 up to the gate stacks G74, G73, G84, G83, and G92 in the second row between the power metal line PW2 and the power metal line PW3 and a fourth region including the insulating gate CS1 up to the gate stack G11 and the insulating gate CS2 in the first row between the power metal line PW1 and the power metal line PW2.

The IS signal is applied to the first level wiring metal line M25 and the B2 signal is applied to the second level wiring metal line M46. The pair of pass transistors MPT3a and MNT3a is implemented in the gate stacks G83 and G84, respectively. The transistor strings MP31a, MP32a, MN32a, and MN31a are implemented in the gate stacks G92, G73, and G74. The MP32a transistor and the MN32a transistor are implemented in the gate stacks G73 and G74 and the active contacts CA82, CA93, and CA94, respectively, and the MP31 transistor and the MN31 transistor share the active contacts CA93 and CA94 with the MP32 transistor and the MN32 transistor, and are implemented through the active contacts CA93 and CA94 and the gate stack G92, respectively.

The gate stack G92 receives the IS signal from the first full adder circuit 10 by being electrically connected to the active contact CA12b and the first level wiring metal line M25.

The first level wiring metal line M27 is connected to the second level wiring metal line M46 through the via VB15 to receive the input signal B2. The first level wiring metal line M27 is connected to the gate stack G52 through the via CB27. The inverter circuit INV31a is implemented in the gate stack G52 and the active contacts CA62, CA63, and CA53. The inverter circuit INV31a generates the nb2 signal through the active contact CA53, and the signal is inputted to the pass transistor MNT3a through the gate via VB10, the first level wiring metal line M19, the gate contact CB19, and the gate stack G83. The B2 signal is inputted to the pass transistor MPT3a through the first level wiring metal line M27, the gate contact CB28, and the gate stack G84.

The output signal of the pair of pass transistors MPT3a and MNT3a is outputted through the active contact CA82, and the signal of the active contact CA82 is passed through the first level wiring metal line M22 and is outputted to the second level wiring metal line M42. The gate stack 32 receives the xor22 signal through the first level wiring metal line M22 electrically connected to the second level wiring metal line M42, the xor22 signal is inverted in the inverter circuit INV33a including the gate contact G11 and the active contacts CA21, CA22, and CA11, and the xnor22 signal is generated in the active contact CA11. The xnor22 signal is electrically connected to the pass transistors MNT11a, MPT12a, and MN22a through the first level wiring metal lines M1 and M14 and the second level wiring metal line M41.

The CI2 signal is received through the first level wiring metal line M18 and is applied to the gate stack G2 through the gate contact CB18, and the nci2 signal inverted by the inverter circuit INV2a is generated at the active contact CA3. The nci2 signal as the inverted carry signal is electrically connected to the gate stack G51 through the first level wiring metal line M12 through the active via VA6. The gate stack G51 is the gate of the transistors MP21a and MN21a.

The transistors MP22a and MN22a receive the xor2 signal and the xnor2 signal to the gate stacks G41 and G42, respectively, and generate the output signal S from the active contact CA41 electrically connected to the first level wiring metal line M12.

In other words, one aspect of the compressor circuit of the present disclosure includes a first full adder circuit that receives an A1 signal, a B1 signal, and a CI signal to output an IS signal and an ICO signal, and a second full adder circuit that receives a B2 signal, the IS signal, and a CI2 signal to output an S signal and a CO signal.

The second full adder circuit includes a first power metal line PW1, a second power metal line PW2, and a third power metal line PW3 that extend in a first direction and are disposed to be spaced apart from each other at a predefined interval in a second direction, a first inverter circuit INV31a that is disposed between the first power metal line PW1 and the second power metal line PW2 and inverts the B2 signal to generate an nb2 signal, a first XNOR circuit 210 that is disposed between the second power metal line PW2 and the third power metal line PW3 and receives the IS signal and the B2 signal to output an xor22 signal and an xnor22 signal, a first XOR circuit 230 that is disposed adjacent to the first inverter circuit INV31a in the first direction between the first power metal line PW1 and the second power metal line PW2 and performs an XOR operation on the CI2 signal and the xor22 signal to output the S signal, a second inverter circuit INV2a that is disposed adjacent to the first XNOR circuit 210 between the second power metal line PW2 and the third power metal line PW3 and inverts the CI2 signal to generate the nci2 signal, and a first multiplexer circuit 220 that is disposed adjacent to the second inverter circuit INV2a in the first direction X between the second power metal line PW2 and the third power metal line PW3 and outputs the B2 signal or the CI signal as the S signal according to the xor22 signal and the xnor22 signal.

The first full adder circuit 10 includes a second XNOR circuit 110 that is disposed adjacent to the first multiplexer circuit 120 in the first direction between the first power metal line PW1 and the second power metal line PW2 and receives the A1 signal and the B1 signal to generate an xor21 signal and an xnor21 signal, a second multiplexer circuit 120 that is disposed adjacent to the second XNOR circuit 110 in the first direction between the first power metal line PW1 and the second power metal line PW2 and outputs the ICO signal by selecting the B1 signal or the CI signal according to the xor21 signal and the xnor21 signal, and a second XOR circuit 130 that is disposed adjacent to the first XNOR circuit 210 in the first direction between the second power metal line PW2 and the third power metal line PW3 and performs an XOR operation on the CI signal and the xor21 signal to output the IS signal.

The second XNOR circuit 110 includes a third inverter circuit INV32 that inverts the A1 signal to output an na signal, a pair of first pass transistors MPT3 and MNT3 that passes the na signal according to the B1 signal, first transistor strings MP31, MP32, MN32, and MN31 that output the output signal of the pair of first pass transistors as the xor21 signal according to the na signal, the B1 signal, and an nb signal obtained by inverting the B1 signal, and a fourth inverter circuit INV33 that inverts the xor21 signal to output the xnor21 signal.

The first XNOR circuit 210 includes a pair of second pass transistors MPT3a and MNT3a that pass the na signal according to the B2 signal, second transistor strings MP31a, MP32a, MN32a, and MN31a that output the output signal of the pair of second pass transistors as the xor22 signal according to the IS signal, the B2 signal, and the nb2 signal obtained by inverting the B2 signal, and a fifth inverter circuit INV33a that inverts the xor22 signal to output the xnor22 signal.

The first full adder circuit includes a first active contact CA12b that is included in the second XOR circuit 130, extends in the second direction Y, and generates the IS signal, a first level first wiring connection line M25 that extends in the first direction across the second XOR circuit 130 and the first XNOR circuit 210 and is electrically connected to the first active contact CA12b to transmit the IS signal, a first gate stack G92 that is included in the first XNOR circuit 210, extends in the second direction, and intersects and is electrically connected to the first level first wiring connection line M25, and a second active contact CA72 that is included in the first XNOR circuit 210, extends in the second direction, and intersects and is electrically connected to the first level first wiring connection line M25.

Looking at the illustrated layout, the first full adder circuit 10 and the second full adder circuit 20 have only a difference in the disposition in the region of the XNOR circuits 110 and 210, and the dispositions of the multiplexer circuit 120 and the XOR circuit 130 are in a point-symmetrical relationship with each other. That is, the first full adder circuit 10 includes the inverter circuit INV32, but the second full adder circuit 20 does not include an inverter circuit to invert the IS signal, so that the number of transistors in the second full adder circuit 20 may be smaller than that in the first full adder circuit 10.

According to the illustrated embodiment, each of the first full adder circuit 10 and the second full adder circuit 20 is disposed in an L-shaped layout in a double height structure. According to some embodiments, the XOR circuit 230, the XNOR circuit 110, and the multiplexer circuit 120 may be disposed adjacent to each other in the X direction between the power metal line PW1 and the power metal line PW2. In addition, the multiplexer circuit 220, the XNOR circuit 210, and the XOR circuit 130 may be disposed adjacent to each other in the X direction between the power metal line PW2 and the power metal line PW3.

The L-shaped layout of the first full adder circuit 10 and the L-shaped layout of the second full adder circuit 20 are disposed such that the bent portions are point-symmetrically engaged with each other, and the semiconductor integrated circuit for the 4-2 compressor circuit has a rectangular layout shape without white space (i.e., portions that are not needed in the layout).

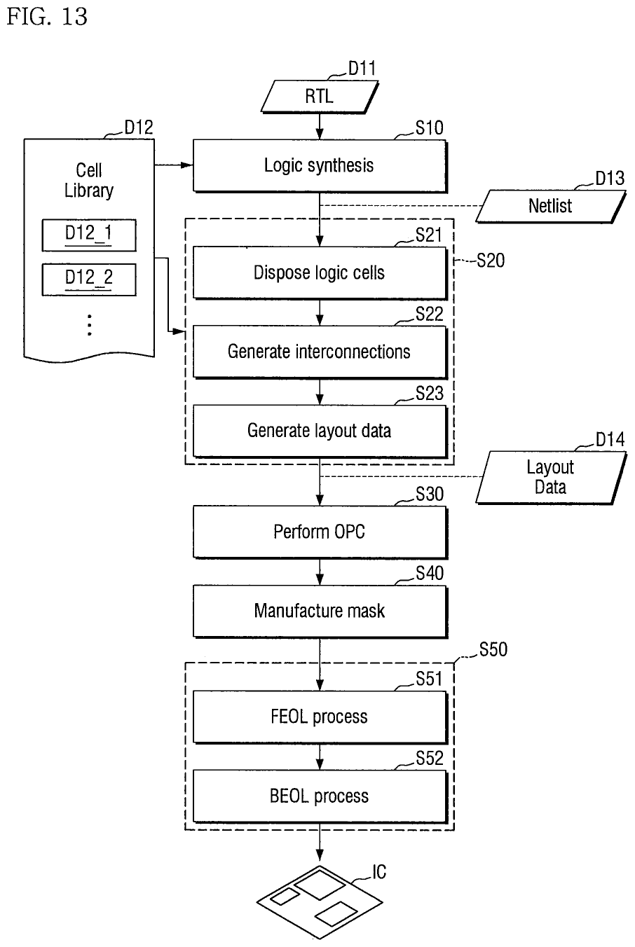

FIG. 13 is a flowchart illustrating a method for fabricating a semiconductor integrated circuit (IC) according to some embodiments.

Referring to FIG. 13, a cell library D12 may include information about the 4-2 compressor circuit of FIGS. 5 to 12. For example, layout information for logic cells of the compressor circuit 1 may be included. In some embodiments, the cell library D12 may include data D12_1, D12-2, and the like defining a layout for a logic cell. The layout of the 4-2 compressor circuit 1 may be defined as standard cells, and the standard cells may have a structure conforming to a predetermined standard according to some embodiments described above.

In step S10, a logic synthesis operation for generating netlist data D13 from register transfer level (RTL) data D11 may be performed. For example, the semiconductor design tool may refer to the cell library D12 and perform logical synthesis from the RTL data D11 written in hardware description language (HDL) to generate the netlist data D13 including a bitstream or a netlist. The HDL may include VHSIC hardware description language (VHDL) and Verilog. The cell library D12 may include information such as the height of the logic cell, the number of pins included in the logic cell, and the number of tracks corresponding to the logic cell. The logic cells may be included in the integrated circuit IC with reference to information of the cell library D12 during the logic synthesis process.

In step S20, a place & routing (P&R) operation for generating layout data D14 from the netlist data D13 may be performed. The P&R step (step S20) may include a plurality of steps S21, S22, and S23.

In step S21, an operation of disposing logic cells may be performed. For example, a semiconductor design tool (e.g., a P&R tool) may dispose a plurality of logic cells with reference to the cell library D12 from the netlist data D13.

In step S21, an operation of disposing power rails may be performed.

In step S22, an operation of generating interconnections may be performed. Through the interconnection operation, an output pin and an input pin of the logic cell may be electrically connected. A logic cell may include at least one via.

In step S23, an operation of generating the layout data D14 may be performed. The layout data D14 may include geometric information of cells and interconnections. The layout data D14 may have a format such as GDSII.

In step S30, a pattern on a mask may be determined by performing an optical proximity correction (OPC) on layout data D74. That is, a pattern having a desired shape may be formed by correcting a distortion phenomenon such as refraction caused by the characteristics of light in the layout data D74. In some embodiments, the layout of the integrated circuit may be limitedly modified in step S30. Through this, the structure of the integrated circuit may be optimized. Step S30 may be referred to as design polishing.

In step S40, an operation of manufacturing a mask may be performed. In order to form the patterns determined in step S30, at least one mask may be manufactured. The mask may include a photo mask.

In step S50, an operation of fabricating an integrated circuit may be performed. For example, an integrated circuit may be fabricated by patterning a plurality of layers using the at least one mask manufactured in step S40. As illustrated in FIG. 17, step S50 may include steps S51 and S52.

In step S51, a front-end-of-line (FEOL) process may be performed. FEOL may refer to forming individual elements on a substrate. Individual elements may include transistors, capacitors, resistors, and the like. The FEOL process may include planarizing a wafer, cleaning the wafer, forming a trench, forming a well, forming a gate line, forming a source and a drain, and the like.

In step S52, a back-end-of-line (BEOL) process may be performed. BEOL may refer to the process of interconnecting individual elements. For example, BEOL may include performing silicidation of gate, source and drain regions, adding dielectric, planarizing, forming a hole, adding a metal layer, forming a via, forming a passivation layer, and the like.

After going through step S52, the packaged integrated circuit (IC) may be used as a component in various applications.

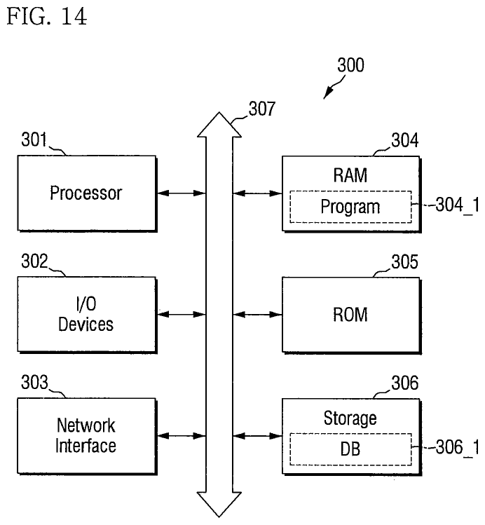

FIG. 14 is a block diagram illustrating a computing system including a memory that stores a program according to some embodiments. At least some among the steps included in the method for fabricating a semiconductor integrated circuit (e.g., the method of FIG. 13) and the steps included in the method of designing the semiconductor integrated circuit (e.g., the method of FIG. 13) according to some embodiments, may be performed in a computing system 300.

The computing system 300 may be a stationary computing system such as a desktop computer, a workstation, and a server, or a portable computing system such as a laptop computer. As illustrated in FIG. 14, the computing system 300 may include a processor 301, input and output (I/O) devices 302, a network interface 303, a random access memory (RAM) 304, a read only memory (ROM) 305, and a storage device 306. The processor 301, the input and output devices 302, the network interface 303, the RAM 304, the ROM 305, and the storage device 306 may be connected to a bus 307, and may communicate with each other via the bus 307.

The processor 301 may be referred to as a processing unit, and may include at least one core capable of executing an arbitrary instruction set (e.g., Intel Architecture-32 (IA-32), 64-bit extended IA-32, ×86-64, PowerPC, Sparc, MIPS, ARM, IA-64, and the like), such as a micro-processor, an application processor (AP), a digital signal processor (DSP), and/or a graphic processing unit (GPU)). For example, the processor 301 may access a memory, that is, the RAM 304 or the ROM 305, via the bus 307, and execute instructions stored in the RAM 304 or the ROM 305.

The RAM 304 may store a program 304_1 or at least a portion thereof for fabricating an integrated circuit according to example embodiments of the present disclosure, and the program 304_1 may cause the processor 301 to perform at least some of the steps included in the method for fabricating the integrated circuit and the steps included in the method of designing the integrated circuit. That is, the program 304_1 may include a plurality of instructions executable by the processor 301, and the plurality of instructions included in the program 304_1, for example, may cause the processor 301 to perform at least some of the steps included in the above-described flowchart with reference to FIG. 13.

The storage device 306 may not lose stored data although the power supplied to the computing system 300 is cut off. For example, the storage device 306 may include a non-volatile memory device, and may include a storage medium such as a magnetic tape, optical disk, or magnetic disk. In addition, the storage device 306 may be detachable from the computing system 300. The storage device 306 may store the program 304_1 according to example embodiments of the present disclosure, and the program 304_1 or at least a portion thereof may be loaded into the RAM 304 from the storage device 306 before the program 304_1 is executed by the processor 301. In some embodiments, the storage device 306 may store a file written in a programming language, and the program 304_1 generated from the file by a compiler and the like or at least a portion thereof may be loaded into the RAM 304. In addition, the storage device 306 may store a database 306_1, and the database 306_1 may include information necessary for designing an integrated circuit, for example, the standard cell library D12 of FIG. 13.

The storage device 306 may store data to be processed by the processor 301 or data processed by the processor 301. That is, the processor 301 may generate data by processing data stored in the storage device 306 according to the program 304_1, and may store the generated data in the storage device 306. For example, the storage device 306 may store the RTL data D11, the netlist data D13, and/or the layout data D14 of FIG. 13.

The input and output devices 302 may include an input device such as a keyboard and a pointing device, and may include an output device such as a display device and a printer. For example, the user may trigger the execution of the program 304_1 by the processor 301 through the input and output devices 302, may input the RTL data D11 and/or the netlist data D13 of FIG. 13, and may check the layout data D14 of FIG. 13.

The network interface 303 may provide access to a network external to the computing system 300. For example, a network may include multiple computing systems and communication links, and the communication links may include wired links, optical links, wireless links, or any other form of links.

In concluding the detailed description, those skilled in the art will appreciate that many variations and modifications can be made to the embodiments described herein without substantially departing from the principles of the present disclosure. Therefore, the disclosed embodiments of the invention are used in a generic and descriptive sense only and not for purposes of limitation.

What is claimed is:

1. A compressor circuit comprising:
a first XNOR circuit configured to receive a first input signal and a second input signal and output a first xor signal and a first xnor signal;
a first multiplexer circuit configured to output an intermediate carry signal by selection between the second input signal and a first input carry signal according to the first xor signal and the first xnor signal;
a first XOR circuit configured to perform an XOR operation on the first input carry signal and the first xor signal to output an intermediate sum signal;
a second XNOR circuit configured to receive the intermediate sum signal and a third input signal and output a second xor signal and a second xnor signal;
a second multiplexer circuit configured to output a final carry signal by selection between the third input signal and a second input carry signal according to the second xor signal and the second xnor signal; and
a second XOR circuit configured to perform an XOR operation on the second input carry signal and the second xor signal to output a final sum signal.

2. The compressor circuit of claim 1, wherein the compressor circuit comprises a plurality of power metal lines extending in a first direction and spaced apart from each other in a second direction, and
wherein the second XOR circuit, the first XNOR circuit, and the first multiplexer circuit are between a first power metal line and a second power metal line of the plurality of power metal lines.

3. The compressor circuit of claim 2, wherein the second multiplexer circuit, the second XNOR circuit, and the first XOR circuit are between the second power metal line and a third power metal line of the plurality of power metal lines.

4. The compressor circuit of claim 1, wherein the first XNOR circuit has a smaller number of transistors than the second XNOR circuit.

5. The compressor circuit of claim 4, wherein the first XNOR circuit comprises:
a first inverter circuit configured to invert the first input signal to output a first inverted input signal;
a pair of first pass transistors configured to pass the first inverted input signal according to the second input signal;
first transistor strings configured to output an output signal of the pair of first pass transistors as the first xor signal according to the first inverted input signal, the second input signal, and a second inverted input signal; and
a second inverter circuit configured to invert the first xor signal to output the inverted signal as the first xnor signal.

6. The compressor circuit of claim 5, wherein the second XNOR circuit comprises:
a pair of second pass transistors configured to pass the intermediate sum signal according to the third input signal;
second transistor strings configured to output an output signal of the pair of second pass transistors as the second xor signal according to the intermediate sum signal, the third input signal, and a third inverted input signal; and
a third inverter circuit configured to invert the second xor signal to output the second xor signal that was inverted as the second xnor signal.

7. The compressor circuit of claim 6, further comprising:
a first active contact in the first XOR circuit, extending in a second direction, and configured to generate the intermediate sum signal;
a first level first wiring connection line extending in a first direction across the first XOR circuit and the second XNOR circuit, electrically connected to the first active contact, and configured to transmit the intermediate sum signal;
a first gate stack in the second XNOR circuit, extending in the second direction, and electrically connected to the first level first wiring connection line while intersecting the first level first wiring connection line; and
a second active contact in the second XNOR circuit, extending in the second direction, and electrically connected to the first level first wiring connection line while intersecting the first level first wiring connection line.

8. A semiconductor integrated circuit comprising a compressor circuit,
wherein the compressor circuit comprises:
a first full adder circuit configured to receive an A1 signal, a B1 signal, and a CI signal, and configured to output an IS signal and an ICO signal, and
a second full adder circuit configured to receive a B2 signal, the IS signal, and a CI2 signal, and configured to output an S signal and a CO signal,
wherein the second full adder circuit comprises:
a first power metal line, a second power metal line, and a third power metal line extending in a first direction, and spaced apart from each other in a second direction at a predefined interval;
a first inverter circuit between the first power metal line and the second power metal line, and configured to invert the B2 signal to generate an nb2 signal;
a first XNOR circuit between the second power metal line and the third power metal line, and configured to receive the IS signal and the B2 signal and output an xor22 signal and an xnor22 signal;
a first XOR circuit adjacent to the first inverter circuit in the first direction between the first power metal line and the second power metal line, and configured to perform an XOR operation on the CI2 signal and the xor22 signal to output the S signal;
a second inverter circuit adjacent to the first XNOR circuit between the second power metal line and the third power metal line, and configured to invert the CI2 signal to generate an nci2 signal; and
a first multiplexer circuit adjacent to the second inverter circuit in the first direction between the second power metal line and the third power metal line, and configured to output the B2 signal or the CI signal as the S signal according to the xor22 signal and the xnor22 signal.

9. The semiconductor integrated circuit of claim 8, wherein the first full adder circuit comprises:
a second XNOR circuit adjacent to the first multiplexer circuit in the first direction between the first power metal line and the second power metal line, and configured to receive the A1 signal and the B1 signal, and configured to generate an xor21 signal and an xnor21 signal;
a second multiplexer circuit adjacent to the second XNOR circuit in the first direction between the first power metal line and the second power metal line, and configured to output the ICO signal by selecting the B1 signal or the CI signal according to the xor21 signal and the xnor21 signal; and
a second XOR circuit adjacent to the first XNOR circuit in the first direction between the second power metal line and the third power metal line, and configured to perform an XOR operation on the CI signal and the xor21 signal to output the IS signal.

10. The semiconductor integrated circuit of claim 9, wherein the second XNOR circuit has a smaller number of transistors than the first XNOR circuit.

11. The semiconductor integrated circuit of claim 9, wherein the second XNOR circuit comprises:
a third inverter circuit configured to invert the A1 signal to output an na signal;
a pair of first pass transistors configured to pass the na signal according to the B1 signal;
first transistor strings configured to output an output signal of the pair of first pass transistors as the xor21 signal according to the na signal, the B1 signal, and an nb signal obtained by inverting the B1 signal; and
a fourth inverter circuit configured to invert the xor21 signal to output the xor21 signal that was inverted as the xnor21 signal.

12. The semiconductor integrated circuit of claim 11, wherein the first XNOR circuit comprises:
a pair of second pass transistors configured to pass the IS signal according to the B2 signal;
second transistor strings configured to output an output signal of the pair of second pass transistors as the xor22 signal according to the IS signal, the B2 signal, and an nb2 signal obtained by inverting the B2 signal; and
a fifth inverter circuit configured to invert the xor22 signal to output the xor22 signal that was inverted as the xnor22 signal.

13. The semiconductor integrated circuit of claim 12, further comprising:
a first active contact in the second XOR circuit, extending in a second direction, and configured to generate the IS signal;
a first level first wiring connection line extending in a first direction across the second XOR circuit and the first XNOR circuit, and electrically connected to the first active contact to transmit the IS signal;
a first gate stack in the first XNOR circuit, extending in the second direction, and electrically connected to the first level first wiring connection line while intersecting the first level first wiring connection line; and
a second active contact in the first XNOR circuit, extending in the second direction, and electrically connected to the first level first wiring connection line while intersecting the first level first wiring connection line.

14. The semiconductor integrated circuit of claim 8, wherein each of the first full adder circuit and the second full adder circuit is in an L-shaped layout in a double height structure, and
wherein the first full adder circuit and the second full adder circuit have bent portions that are point-symmetrically engaged with each other, and the compressor circuit is in a rectangular shape.

15. A semiconductor integrated circuit comprising a compressor circuit,
wherein the compressor circuit comprises: a first full adder circuit configured to receive an A1 signal, a B1 signal, and a CI signal and configured to output an IS signal and an ICO signal, and a second full adder circuit configured to receive a B2 signal, the IS signal, and a CI2 signal and configured to output an S signal and a CO signal,
wherein each of the first full adder circuit and the second full adder circuit is in an L-shaped layout, the first full adder circuit and the second full adder circuit have bent portions that are point-symmetrically engaged with each other, and the compressor circuit is in a rectangular shape, and
wherein a number of transistors in the second full adder circuit is smaller than a number of transistors in the first full adder circuit.

16. The semiconductor integrated circuit of claim 15, wherein the second full adder circuit comprises:
a first power metal line, a second power metal line, and a third power metal line extending in a first direction, and spaced apart from each other in a second direction at a predefined interval;
a first inverter circuit between the second power metal line and the third power metal line, and configured to invert the B2 signal to generate an nb2 signal;
a first XNOR circuit between the second power metal line and the third power metal line to receive the IS signal and the B2 signal to generate an xor22 signal, and between the first power metal line and the second power metal line to generate the xor22 signal as an xnor22 signal;
a first XOR circuit adjacent to the first inverter circuit in the first direction between the second power metal line and the third power metal line, and configured to perform an XOR operation on the CI2 signal and the xor22 signal to output the S signal;
a second inverter circuit adjacent to the first XNOR circuit between the second power metal line and the third power metal line, and configured to invert the CI2 signal to generate an nci2 signal; and
a first multiplexer circuit adjacent to the second inverter circuit in the first direction between the second power metal line and the third power metal line, and configured to output the B2 signal or the CI signal as the S signal according to the xor22 signal and the xnor22 signal.

17. The semiconductor integrated circuit of claim 16, wherein the first full adder circuit comprises:
a second XNOR circuit adjacent to the first multiplexer circuit in the first direction between the first power metal line and the second power metal line, and configured to receive the A1 signal and the B1 signal, and configured to generate an xor21 signal and an xnor21 signal;
a second multiplexer circuit adjacent to the second XNOR circuit in the first direction between the first power metal line and the second power metal line, and configured to output the ICO signal by selecting the B1 signal or the CI signal according to the xor21 signal and the xnor21 signal; and
a second XOR circuit adjacent to the first XNOR circuit in the first direction between the second power metal line and the third power metal line, and configured to perform an XOR operation on the CI signal and the xor21 signal to output the IS signal.

18. The semiconductor integrated circuit of claim 16, wherein the second full adder circuit further comprises:
a second level first wiring metal line extending in the second direction and configured to transmit the xor22 signal; and
a second level second wiring metal line extending in the second direction and configured to transmit the xnor22 signal,
wherein the first multiplexer circuit and the first XOR circuit are adjacent to each other in the second direction to share the second level first wiring metal line and the second level second wiring metal line.

19. The semiconductor integrated circuit of claim 17, wherein the second XNOR circuit comprises:
a third inverter circuit configured to invert the A1 signal to output an na signal;
a pair of first pass transistors configured to pass the na signal according to the B1 signal;
first transistor strings configured to output an output signal of the pair of first pass transistors as the xor21 signal according to the na signal, the B1 signal, and an nb signal obtained by inverting the B1 signal; and
a fourth inverter circuit configured to invert the xor21 signal to output the xor21 signal that was inverted as the xnor21 signal.

20. The semiconductor integrated circuit of claim 19, wherein the first XNOR circuit comprises:
a pair of second pass transistors configured to pass the IS signal according to the B2 signal;
second transistor strings configured to output an output signal of the pair of second pass transistors as the xor22 signal according to the IS signal, the B2 signal, and an nb2 signal obtained by inverting the B2 signal; and
a fifth inverter circuit configured to invert the xor22 signal to output the xor22 signal that was inverted as the xnor22 signal.
